(19) United States
(12) Patent Application Publication
(10) Pub. No.: US 2008/0292796 A1
(43) Pub. Date: Nov. 27, 2008

(54) Method and Apparatus for Forming Plated Liquid Crystalline Polymer Substrate

(76) Inventor: Steven Lee Dutton, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/123,330

(22) Filed: May 19, 2008

Related U.S. Application Data
(60) Provisional application No. 60/939,000, filed on May 18, 2007.

(51) Int. Cl. B05D 3/00

(52) U.S. Cl. 427/294

(57) ABSTRACT

A method and apparatus for forming plated liquid crystalline polymer substrates which includes placing a plated liquid crystalline polymer substrate on or within a fixture and applying vacuum and heat to the fixture and the plated liquid crystalline polymer substrate. The plated liquid crystalline polymer substrate may contain printed circuits and can be formed to any shape, configuration, and size without destroying the printed circuits contained on the liquid crystalline polymer substrate.

### CROSS-REFERENCE TO RELATED APPLICATIONS

This application claims priority to provisional patent application having Ser. No. 60/939,000, filed May 18, 2007, which is herein incorporated in its entirety.

### FIELD OF INVENTION

The present invention relates to a method and apparatus for forming plated liquid crystalline polymer substrates. More particularly, the present invention relates to a method and apparatus for forming plated liquid crystalline polymer substrates by placing a plated liquid crystalline polymer substrate within a fixture and applying vacuum and heat to the fixture containing the plated liquid crystalline polymer substrate.

### SUMMARY OF THE INVENTION

The present invention is directed to a method and apparatus for forming plated liquid crystalline polymer substrates. The plated liquid crystalline polymer substrates may contain printed circuits and can be formed to any shape, configuration, and size without destroying the printed circuits contained on the liquid crystalline polymer substrate.

One exemplary method of the present invention for forming a plated liquid crystalline polymer substrate includes the steps of providing a plated liquid crystalline polymer substrate, creating a fixture for containing the plated liquid crystalline polymer substrate, placing the plated liquid crystalline polymer substrate within the fixture, placing the fixture containing the plated liquid crystalline polymer substrate within a vacuum bag, heating the vacuum bag and fixture containing the plated liquid crystalline polymer substrate contained within the vacuum bag, and finally cooling the plated liquid crystalline polymer substrate and removing it from the fixture. The vacuum and heat applied to the plated liquid crystalline polymer substrate removes the memory of the plated liquid crystalline polymer substrate and changes the memory of the plated liquid crystalline polymer substrate to comport with the fixture. Subsequently, when the plated liquid crystalline polymer substrate is cooled and removed from the fixture, it retains a new memory which comports with the fixture.

Any number of different processing times may be used for the vacuum and heat in order to change the memory of the plated liquid crystalline polymer material. In another exemplary embodiment of the invention, the plated liquid crystalline polymer material contained within the fixture may be vacuum baked at 250 degrees Fahrenheit for approximately two hours. However, it will be understood by those skilled in the art that any number and variety of vacuum and heat parameters may be applied to the plated liquid crystalline polymer substrate as long as the vacuum and heat parameters allow the plated liquid crystalline polymer substrate to advance through its melt properties before being allowed to cool.

It will be understood by those skilled in the art that any type of fixture may be utilized in accordance with the method for forming plated liquid crystalline polymer substrates in accordance with the present invention. A fixture used in accordance with the present invention may include a fixture having any shape, size, and configuration as long as the fixture enables a plated liquid crystalline polymer substrate to be held within or adjacent to the fixture.

### BRIEF DESCRIPTION OF THE DRAWINGS

FIG. 1 is a flow chart depicting an exemplary embodiment of the method of the present invention for forming plated liquid crystalline polymer substrates.

FIG. 2 is a sheet of drawings showing various views of an exemplary fixture that may be used in accordance with the method of the present invention for forming plated liquid crystalline polymer substrates.

FIG. 3 is a top view of the first layer of a plated liquid crystalline polymer substrate shown before a forming.

FIG. 4 is a front elevational view of the plated liquid crystalline polymer substrate shown before forming.

FIG. 5 is a top view of a second layer of plated liquid crystalline polymer substrate shown before forming.

FIG. 6 is a top view of the first layer of the plated liquid crystalline polymer substrate shown after forming.

FIG. 7 is a front elevational view of the plated liquid crystalline polymer substrate shown after forming.

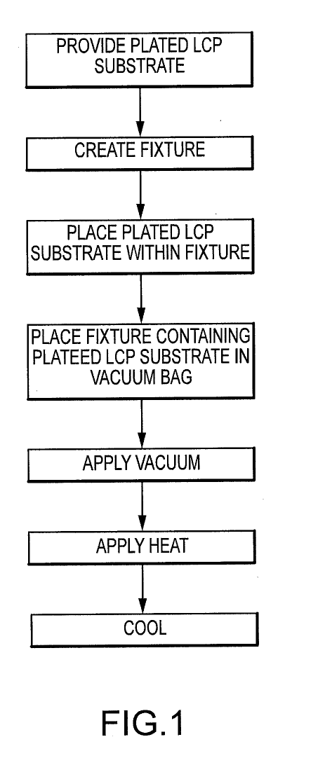

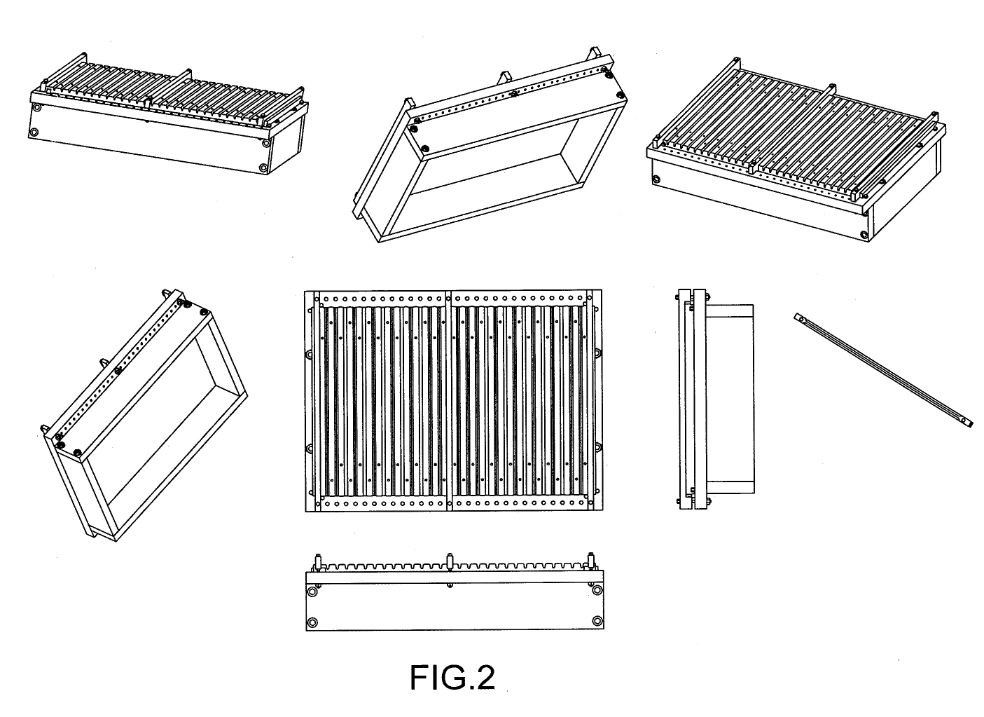

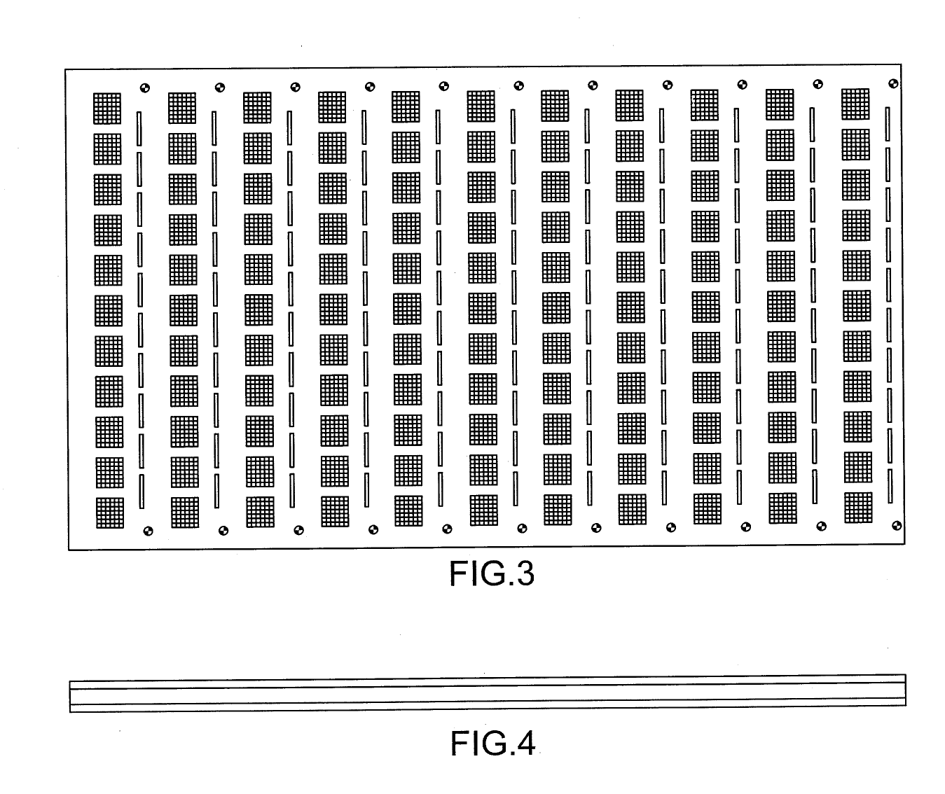

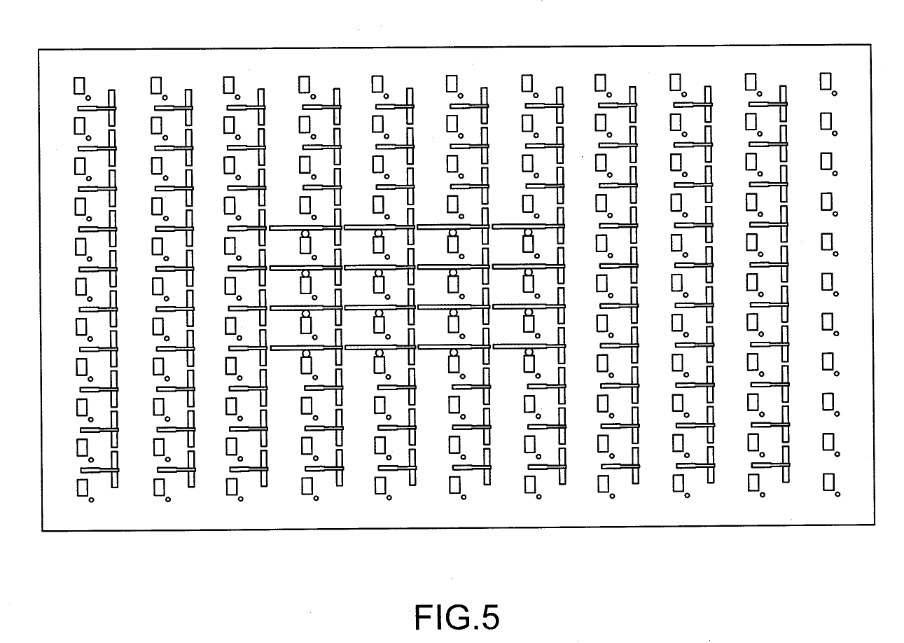

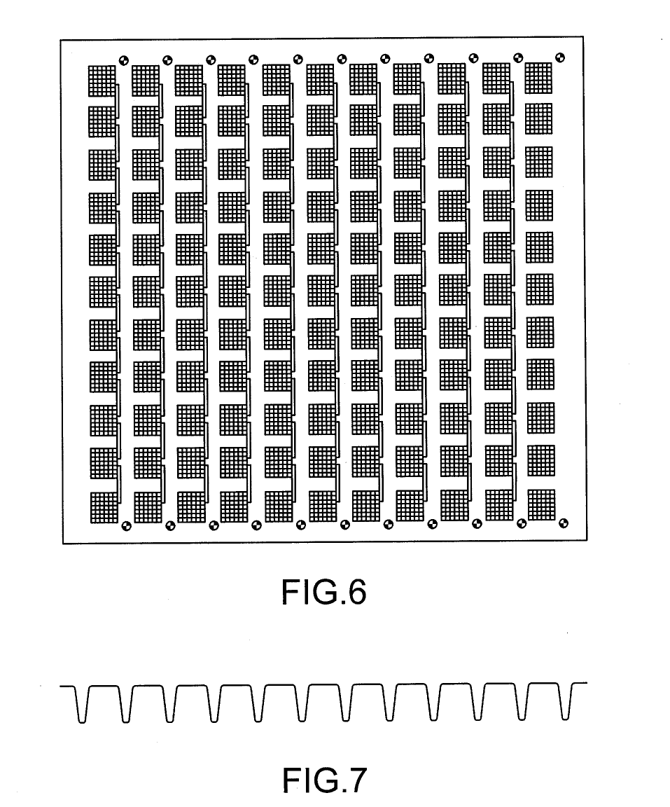

1. A method for forming a plated liquid crystalline polymer substrate comprising the steps of:
providing a plated liquid crystalline polymer substrate;
creating a fixture for containing or forming the plated liquid crystalline polymer substrate;
placing the liquid crystalline polymer substrate on or within the fixture;
placing the fixture and liquid crystalline polymer substrate within a vacuum bag;
heating the vacuum bag, the fixture, and the plated liquid crystalline polymer substrate; and
cooling the plated liquid polymer substrate and removing it from the fixture.
